(19) United States
(12) Patent Application Publication
(10) Pub. No.: US 2021/0127832 A1
(43) Pub. Date: May 6, 2021

(54) LIGATURE RESISTANT HINGE COVER

(71) Applicant: Abdullah Shahzad, Aurora, IL (US)

(72) Inventor: Abdullah Shahzad, Aurora, IL (US)

(73) Assignee: The Norix Group, West Chicago, IL (US)

(21) Appl. No.: 16/669,236

(22) Filed: Oct. 30, 2019

(51) Int. Cl. A47B 96/20; F16B 12/10

(52) U.S. Cl. CPC A47B 96/20; E05Y 2900/20; A47B 2220/0072; F16B 12/10

(57) ABSTRACT

The ligature resistant hinge cover comprising a bridge between a cabinet and a hinge mounted door. The ligature resistant hinge cover comprising a cabinet face portion on the cabinet and a door portion disposed adjacent a door hinge side whereby the door portion is adapted to close a gap between the door hinge side and the ligature resistant hinge cover. The ligature resistant hinge cover further comprising a sloping top portion bridging the gap between the top of the door and the top of the cabinet with a sloping rounded top edge. A concave hinge portion adjacent the hinge. A convex outside adapted to provide a smooth transition from the cabinet to the door.

### FIELD OF THE INVENTION

The present ligature resistant hinge cover relates generally to anti-ligature covers for furniture openings specifically, hinge covers for closing a space between a hinge and a top of the furniture, and the like.

### BACKGROUND OF THE INVENTION

In special care environments and institutional settings, there may be a need to provide furnishings including furniture that is designed to minimize the chance of self inflicted harm. The safety of a subject needing to be restrained includes preventing danger of harm by ligature. This need includes furniture that is ligature resistant. Ligature resistance includes furniture that does not provide a tie-off such as open loops or holes, sharp corners, protruding fixtures and edges. Of particular importance is furniture design that includes ligature-resistant door/trim designs that eliminate opportunities for a person to harm themselves. For example, if a door is hinged to a door frame, the gap between the door and the door frame must be protected to not provide an attachment point for a ligature that would enable a person to hang or strangle themselves.

Hinged doors are used on shelving and wardrobe type storage container. The hinge may attach to the door and cabinet to support the door in a swinging movement about the hinge from the closed position with door against the cabinet to an open position. Such hinged attachments must be protected to prevent a ligature tie off on top of the hinge between the door and the cabinet. The use of discrete hinges leaves the opening between hinges and above the top hinge as potential tie-offs. The use of a piano type hinge that extends along the entire length of the door prevents the danger posed between discrete hinges but leaves the top of the hinge area unprotected.

Applicant has invented a ligature resistant hinge cover adapted to resist the use of the hinged connection to the door frame as a support for a ligature. It is desired to provide a hinge cover adapted to eliminate a gap between the top of the door and door frame.

### BRIEF SUMMARY OF THE LIGATURE RESISTANT HINGE COVER

The ligature resistant hinge cover comprises a plate mounted on the door frame adjacent the hinge. The door frame may comprise a top overhang above the door and a door support side. The hinge pivotally mounting the door to the door frame may be attached to the door support side or to the front of the door frame. The hinge is further attached to the door at a hinge side. The ligature resistant hinge cover comprises an inside and an outside, a sloped top, a bottom edge, a front edge and a back edge. The sloped top extends from the back edge to the front edge. The sloped top slopes generally downward from the back edge to the front edge wherein the front edge is disposed below a top of the door. The sloped top comprises a top corner on the back edge and bottom corner on the front edge.

The ligature resistant hinge cover is attached to the furniture by a mounting flange attached to the door frame adjacent the hinge. The mounting flange disposes the sloped top above the top of the door to bridge the gap between the cabinet top and the door over the hinge. The ligature resistant hinge cover comprises a spacer adjacent to the door hinge edge. The ligature resistant hinge cover may have a convex shaped outside and a sloping top. The ligature resistant hinge cover may have a sloping top front corner above the door and a bottom front corner level preferably below the top of the door. In the door closed position, the plate is generally perpendicular to the door panel. In the door open position the spacer is generally parallel to and bearing against the door panel. The ligature resistant hinge cover has a sloping top that is sloped from back to front disposed adjacent to and generally level with or below a top edge of the door frame. The sloping top is adapted to be aligned with the top edge of the door in either the door open or door closed orientation. It should be understood that the door frame may be a frame surrounding a door as in a typical man door separating rooms in a building or the door frame may comprise a cabinet, wardrobe or cupboard attached to a door by a hinge.

The outside of the ligature resistant hinge cover may have a convex shape from the sloped top to the bottom edge. The convex shape may extend to the inside forming a knife edge like sloping top bearing against the door frame. The inside of the ligature resistant hinge cover may have a concave shape to surround the top of the door and a portion of the hinge. The concave inside may be adapted to receive and cover the top corner of the furniture.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE SEVERAL VIEWS OF THE DRAWING

FIG. 1 is a back side elevation view of the ligature resistant hinge cover.

FIG. 2 is a top plan view of the ligature resistant hinge cover.

FIG. 3 front elevation view of the ligature resistant hinge cover.

FIG. 4 is a bottom plan view of the ligature resistant hinge cover.

FIG. 5 is a front side elevation view of the ligature resistant hinge cover.

FIG. 6 is a back elevation view of the ligature resistant hinge cover.

FIG. 7 is a top back perspective view of the ligature resistant hinge cover.

FIG. 8 is a top front perspective view of the ligature resistant hinge cover.

FIG. 9 is a perspective view of the ligature resistant hinge cover mounted on a cabinet.

FIG. 10 is a front perspective view of the ligature resistant hinge cover mounted on the cabinet of FIG. 9.

FIG. 11 is a section view showing the ligature resistant hinge cover mounted on a cabinet taken at approximately 11-11 of FIG. 9;

FIG. 12 is a section view showing the ligature resistant hinge cover mounted on a cabinet taken at approximately 12-12 of FIG. 10.

### DETAILED DESCRIPTION OF THE INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

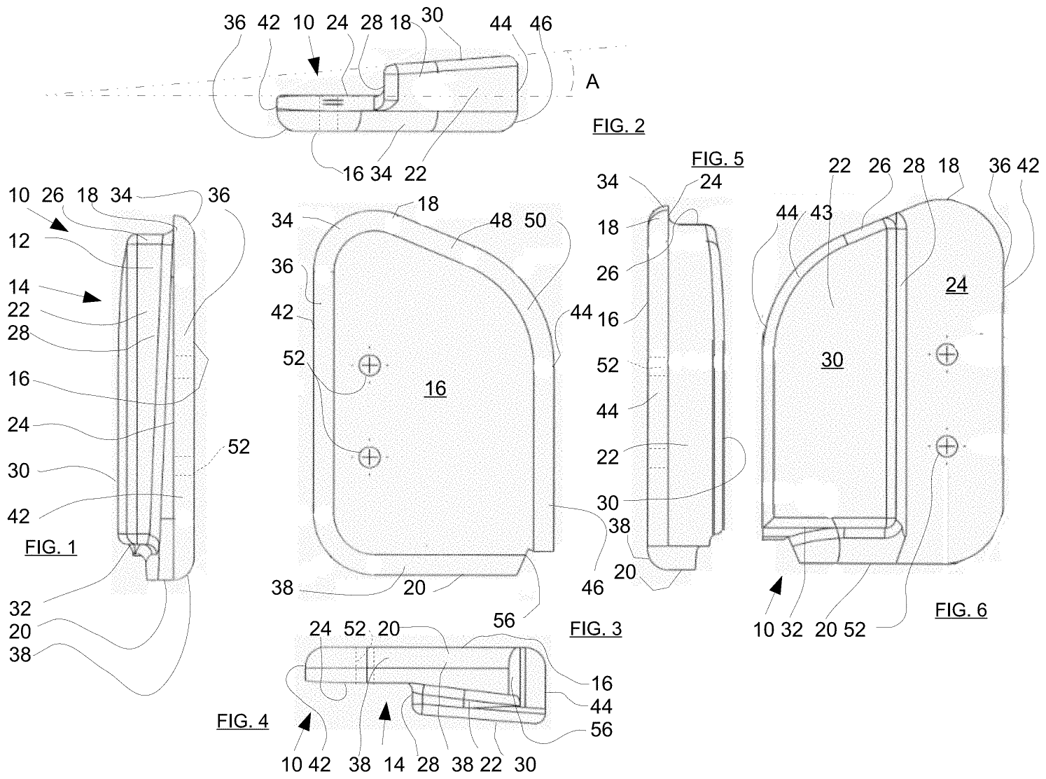

Referring to FIG. 1, the ligature resistant hinge cover 10 comprises a body 12. The body 12 comprises an inside 14, an outside 16, a top 18, and a bottom 20. Inside 14 may further comprise a spacer 22 and a cabinet flange portion 24. Spacer 22 may comprise an spacer top 26, a spacer hinge portion 28 and a spacer door portion 30. Outside 16 may have a convex shape formed by rounded top 34, rounded front edge 36 and rounded bottom edge 38. It should be understood outside 16 may extend smoothly to cabinet flange portion 24 by the rounded edges 34,36 and 38.

Referring to FIG. 2, ligature resistant hinge cover 10 may further comprise a back edge 42 and a front edge 44. Front edge 44 may comprise front rounded corner 43 and a front rounded edge 46. Door portion 30 is spaced from outside 16. Cabinet flange portion 24 and door portion 30 may be at an acute angle A to each other.

Referring to FIG. 3, ligature resistant hinge cover 10 may further comprise sloping top portion 48 extending from back edge 42 to front edge 44. Front edge 44 may further comprise rounded outer edge 46 as part of the convex shape of outside 16. Front edge 44 and bottom 20 are joined at hinge notch 56 disposed in the bottom front corner. Fastener holes 52 extend through body 10 from the inside to the outside. Preferably, fastener holes are disposed in the flange portion 24.

Referring to FIG. 4, cabinet flange portion 24 may extend from door portion 30. Hinge portion 28 extends from door portion 30 to cabinet flange portion 24 giving inside a generally concave shape.

Referring to FIGS. 1-8, ligature resistant hinge cover 10 may comprise a smooth ligature resistant outside 16 having a convex shape extending from the top 18 to the bottom 20 and from the back edge 42 to the front edge 44. Spacer 22 may extend from cabinet flange portion 24 thereby supporting door portion 30 spaced from cabinet flange portion 24. Hinge portion 28 extends between cabinet flange portion 24 to door portion 30, Hinge portion 28 may have a concave shape extending into spacer 22. Sloping top portion 48 is disposed at the same level or above the door top 112. Door portion 30 may be adjacent door hinge side 114. Hinge notch 56 is disposed between door top 112 and hinge 104. Hinge top 18 bears against convex shaped outside 16

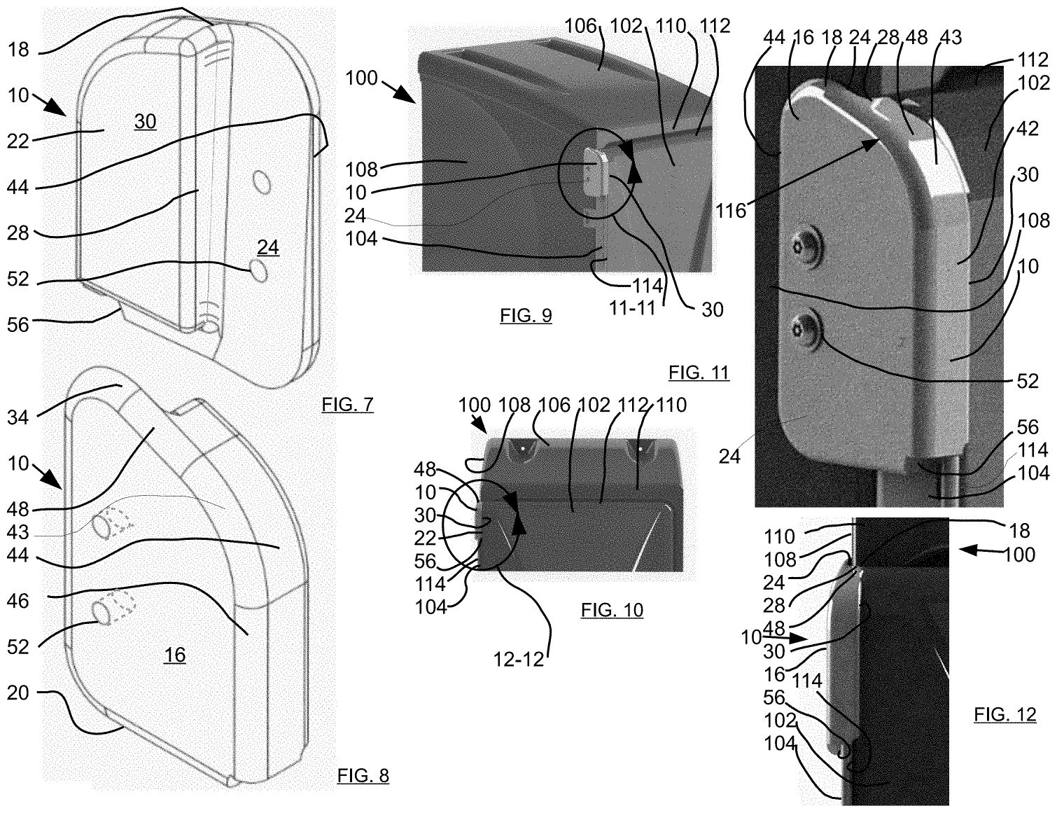

Referring to FIGS. 9 and 11, ligature resistant hinge cover 10 is mounted on a cabinet 100 having a door 102 and a hinge 104. Cabinet 100 may further comprise a sloped top 106, a hinge side 108 and a front side 110. The hinge 104 may be attached to the front side 110 and to the door 102. Door top 112 is spaced from cabinet top 106. Door hinge side 114 may be spaced from hinge side 108. Hinge 104 may be attached to the front side 110 of cabinet 100. Ligature resistant hinge cover 10 may have cabinet flange portion 24 on hinge side 108. Hinge portion 28 may be disposed adjacent hinge 104. Spacer 22 is adapted to dispose door portion 30 adjacent door hinge side 114. Top 18 is adapted to provide a smooth transition from sloping cabinet top 106 to door front 102. Sloping top portion 48 is adapted to bridge the space between door hinge side 114 and door top 112 to thereby provide a ligature-resistant transition from cabinet 100 to door 102.

Referring to FIGS. 11 and 12, ligature-resistant hinge cover 10 may be disposed on hinge side 108 thereby disposing spacer 22 adjacent door hinge side 114. Cabinet flange portion 24 bears against cabinet hinge side 108 and hinge portion 30 may be adjacent door hinge side 114. Convex shaped outside 16 forms ligature resistant sloping bridge 116 between door 102 and cabinet 100.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given. Further, the present invention has been shown and described with reference to the foregoing exemplary embodiments. It is to be understood, however, that other forms, details, and embodiments may be made without departing from the spirit and scope of the invention which is defined in the following claims.

I claim:

1. A ligature resistant hinge cover for use with a door attached to a door frame by a hinge, the hinge on the door frame, the door having a door top and a door hinge side, the hinge on the door hinge side, the hinge cover comprising:
a body, the body comprising an inside, an outside, a back edge, a front edge and a top, the inside on the top, the outside on the top, the top extending between the front edge and the back edge, the top sloped downward from the back edge to the front edge whereby the hinge cover is adapted to be attached to the door frame adjacent the hinge having the top above the door top.

2. The ligature resistant hinge cover of claim 1, wherein the inside is concave.

3. The ligature resistant hinge cover of claim 2, further comprising a bottom on the body, the outside comprising a convex shape between the top and the bottom.

4. The ligature resistant hinge cover of claim 1, wherein the top comprises an arcuate shape from the back edge to the front edge.

5. The ligature resistant hinge cover of claim 1, wherein the top comprises a curved shape between the back edge to the front edge.

6. The ligature resistant hinge cover of claim 1, wherein the top further comprises a convex shape from the outside to the inside.

7. The ligature resistant hinge cover of claim 3, the top further comprising a convex shape between the inside and the outside.

8. The ligature resistant hinge cover of claim 7, wherein the top comprises an arcuate shape from the back edge to the front edge.

9. The ligature resistant hinge cover of claim 8, wherein the inside is concave.

10. The ligature resistant hinge cover of claim 1, further comprising a door spacer on the inside, the door spacer comprising a spacer top, a spacer bottom, a hinge side and a cover side, the spacer top spaced from the sloped top, the spacer top generally symmetrical with the sloped top, the cover side on the inside, the hinge side spaced from the inside, a plurality of fastener holes in the body, each of the plurality of fastener holes extending from the inside to the outside, the plurality of fastener holes disposed between the door spacer and the back.

11. A hinge cover comprising:
a body comprising an inside, an outside, a front edge, a back edge, a sloped top and a bottom, the inside extending between the front edge and the back edge, the outside on the sloped top and the bottom, the outside having a convex shape from the sloped top to the bottom, the sloped top sloping downward from the back edge to the front edge, a plurality of fastener holes in the body extending from the inside to the outside.

12. The ligature resistant hinge cover of claim 11, wherein the sloped top comprises an arcuate shape from the back to the front.

13. The ligature resistant hinge cover of claim 11, the front edge frame further comprising a concave shape between the sloped top and the bottom.

14. The ligature resistant hinge cover of claim 11, further comprising a door spacer on the inside, the door spacer spaced from the plurality of fastener holes.

15. The ligature resistant hinge cover of claim 14, wherein the door spacer further comprises a spacer top, a spacer bottom, a hinge side and a cover side, the spacer top adjacent the sloped top, the cover side on the inside, the front edge spaced from the inside.

16. The ligature resistant hinge cover of claim 15, further comprising a chamfer between the spacer top and the inside.

17. A ligature resistant hinge cover for use with a door attached to a door frame by a hinge, the hinge on the door frame, the door having a door top and a door hinge side, the hinge on the hinge side, the hinge cover comprising:
a body, the body comprising an inside, an outside, a back edge, a front edge, a bottom, a sloped top and a door spacer, the outside extending from the sloped top to the bottom, the outside further extending from the sloped top to the bottom, the outside comprising a convex shape from the sloped top to the bottom, the sloped top disposed between the back edge and the front edge, the sloped top sloping downward from the back edge to the front edge, the door spacer on the front edge, the door spacer comprising a spacer top, a hinge side and a cover side, the cover side on the inside, the spacer top spaced from the sloped top, the hinge side spaced from the inside, whereby the ligature resistant hinge cover is adapted to be attached to the door frame by the hinge side on the door frame adjacent the door hinge side and the sloped top above the door top.
